(19) United States
(12) Patent Application Publication
(10) Pub. No.: US 2007/0088560 A1
(43) Pub. Date: Apr. 19, 2007

(54) Method and system for conveying context information in a personal and family security environment

(75) Inventors: Von A. Mock, Boynton Beach, FL (US); Mark A. Barros, Wellington, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/250,364

(22) Filed: Oct. 14, 2005

(51) Int. Cl. G06Q 99/00

(52) U.S. Cl. 705/1

(57) ABSTRACT

A system (100) and method (200) of conveying context information in a personal and family security environment monitor (201) a sender's environment, encode (202) a context signal that is used to activate a sound, a haptic, or a light representative of the sender's environment, and transmit (206) the context signal. In another aspect, the method can alternatively encode (204) an icon representative of a location or an implied location or an implied heading as the context signal. The method can further include the step of initiating (208) an I'm OK sequence. In one aspect, the method can receive the context signal and generate (210) the sound, haptic, or light representative of the sender's environment at the receiving party.

### FIELD OF THE INVENTION

This invention relates generally to communication devices, and more particularly to an enhanced method and system for conveying context information to a communication device.

### BACKGROUND OF THE INVENTION

Existing personal and family security communication devices can provide an “I'm OK™” function notice to a family member or other concerned person. There are many times when a user just wants to let someone know that they are OK. This can be accomplished by sending a multi-media message with basic information including location and possible image(s) to give more information about the user's surroundings. However, additional information about the user and the user's surroundings or environment is not completely conveyed to the family member receiving the message. Thus, the family member may have additional concerns about the other family member's surroundings or may prefer a richer experience regarding the context of the user's “I'm OK™” message. Note, “I'm OK™” and “I AM OK™” are trademarks of Motorola, Inc. of Schaumburg, Ill.

### SUMMARY OF THE INVENTION

Embodiments in accordance with the present invention can provide a richer experience for an I'm OK application for use with the personal and family security business. Personal and family security members share an affinity between one another and conveyance of information outside of the traditional text and plain images is an important development of the Personal and Family Security “I'm OK” application. An I'm OK application, function, computer software, program or sequence generally describes a transmission, reproduction, or response in the form of sound, data, images or video that can give an indication that someone is fine or “OK”.

In a first embodiment of the present invention, a method of conveying context information in a personal and family security environment can include the steps of monitoring a sender's environment, encoding a context signal that is used to activate a sound, a haptic, or a light representative of the sender's environment, and transmitting the context signal to a receiving party. The method can further include the step of initiating an I'm OK sequence. In one aspect, the method can receive the context signal and generate the sound, haptic, or light representative of the sender's environment at the receiving party. A speaker at the receiving party can generate a sound representative of encoded location information at the sender's environment, a vibrator at the receiving party can generate a haptic representation of an encoded heart beat, or traffic condition, or weather condition, or motion condition of the sender's environment, and a light source at the receiving party can generate a background color representative of a motion condition of the sender's environment. In another aspect, the method can alternatively encode an icon representative of a location or an implied location or an implied heading as the context signal.

In a second embodiment of the present invention, a personal and family security device can include a transceiver, and a processor coupled to the transceiver, a speaker, or color display, or vibrator coupled to the processor. The processor can be programmed to activate the speaker, or color display, or vibrator in a manner representative of a sender's environment. The speaker can generate a sound representative of encoded location information at the sender's environment, the vibrator can generate a haptic representation of an encoded heart beat, or traffic condition, or weather condition, or motion condition of the sender's environment, and the light source can generate a background color representative of a motion condition of the sender's environment. The transceiver can receive an encoded signal representative of the sender's environment in the form of an icon representative of a location or an implied location or an implied heading. Also note, the speaker, or color display, or vibrator can be activated in response to receiving an I'm OK message from a family member.

In a third embodiment of the present invention, a system of conveying context information in a personal and family security environment can include a first transceiver and a first processor coupled to the first transceiver. The processor can be programmed to encode a context signal representative of a sender's environment, a second transceiver, a second processor coupled to the second transceiver, and a speaker, or color display, or vibrator coupled to the second processor. The second processor can be programmed to activate the speaker, or color display, or vibrator in a manner representative of the sender's environment in response to receiving the context signal from the first transceiver. The speaker can generate a sound representative of encoded location information at the sender's environment, the vibrator can generate a haptic representation of an encoded heart beat, or traffic condition, or weather condition, or motion condition of the sender's environment, and the light source can generate a background color representative of a motion condition of the sender's environment. In one aspect, the second transceiver can receive an encoded signal representative of the sender's environment in the form of an icon representative of a location or an implied location or an implied heading. Note, the speaker, or color display, or vibrator can be activated in response to receiving an I'm OK message from a family member.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a system of conveying context information in a personal and family security environment in accordance with an embodiment of the present invention.

FIG. 2 is a flow chart illustrating a method of conveying context information in a personal and family security environment in accordance with an embodiment of the present invention.

FIG. 3 is a flow chart illustrating a method of inserting a sound clip based on location in accordance with an embodiment of the present invention.

FIG. 4 is a flow chart illustrating a method of determining a pulse rate and encoding haptic information in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

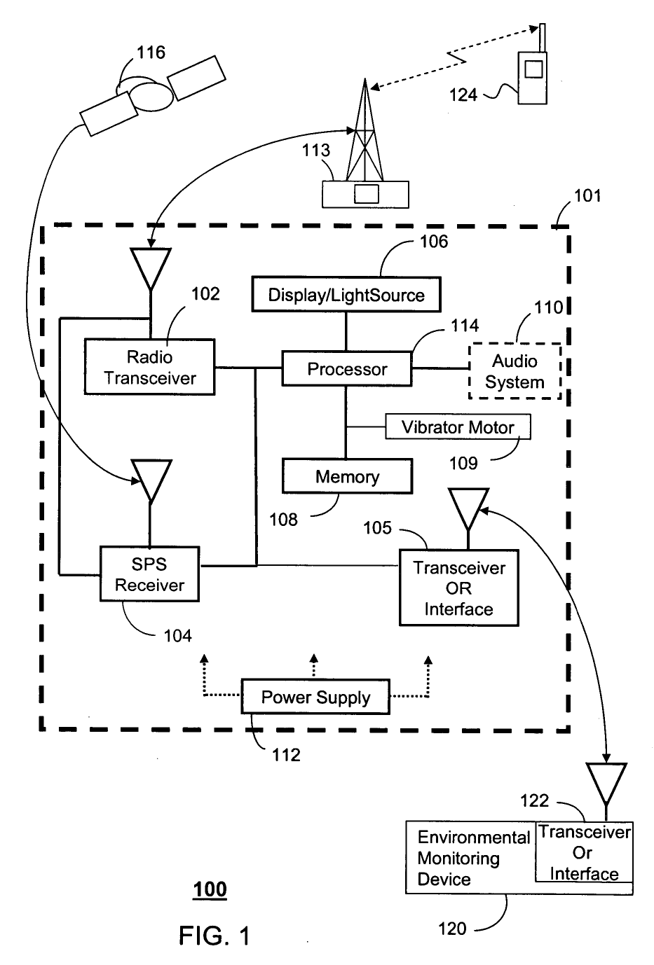

Referring to FIG. 1, a system 100 of conveying context information in a personal and family security environment is shown including an environmental monitoring device 120 operatively coupled to a wireless device 101 via a short range transceiver or interface 122. The environmental monitoring device 120 can monitor any number of environmental factors including, but not limited to a time of day, an acceleration, a road surface texture, a heart beat, an ambient light level, a temperature, an altitude, a barometric pressure, or a humidity level. The monitoring device 120 can be separate as shown or integrated with the wireless communication device 101 which can be a cellular phone. The wireless communication device 101 can further include a wide area network wireless transceiver 102 for communication over a wide area network 113, a transceiver or interface 105 operatively coupled to the wide area network wireless transceiver 102, and a processor 114 coupled to the wide area network wireless transceiver 102 and interface or transceiver 105. The wide area network 113 can include one or more wireless base stations commonly found in cellular communication networks. The processor 114 can be programmed to encode a context signal representative of a sender's environment. The wireless device 101 can further include an optional audio system 110 having a speaker or other audio ports, a light source or color display 106, or a vibrator such as a vibrator motor 109.

The wireless communication device 101 can also include a memory 108 including one or more storage elements (e.g., Static Random Access Memory, Dynamic RAM, Read Only Memory, etc.), the optional audio system 110 for conveying audible signals (e.g., voice messages, music, etc.) to the user of the device, a conventional power supply 112 for powering the components of the device, and the processor 114 comprising one or more conventional microprocessors, microcontrollers, and/or digital signal processors (DSPs) for controlling operations of the foregoing components.

A similarly configured (second) wireless device 124 as (the first) wireless device 101 can also include a transceiver, a processor coupled to the transceiver, and a speaker, or color display, or vibrator coupled to its processor. The processor within device 124, as in device 101, can be programmed to activate its speaker, or color display (or light source), or vibrator in a manner representative of a sender's environment in response to receiving a context signal from a sender's transceiver (102). The speaker can generate a sound representative of encoded location information at the sender's environment, the vibrator can generate a haptic representation of an encoded heart beat, or traffic condition, or weather condition, or motion condition of the sender's environment, and the light source or display can generate a background color representative of a motion condition of the sender's environment. In one aspect, the transceiver 102 (or transceiver within device 124) can receive an encoded signal representative of the sender's environment in the form of an icon representative of a location or an implied location or an implied heading. Note, the speaker, or light source/color display, or vibrator can be activated in response to receiving an I'm OK message from a family member.

The environmental monitoring device 120 can monitor at least one or more environmental parameters to provide the processor 114 with a use context that will enable the processor 114 to encode richer context information that can be used to reflect the sender's environment. As noted above, the wireless communication device 101 can be a cellular phone, but the device 101 can be other wireless communication devices such as personal digital assistants, laptop computers or other devices having the appropriate wireless capability. The wireless device 101 can further include a satellite positioning system (SPS) receiver 104 such as a GPS receiver in communication with one or more satellites 116 for providing location services. The location information can also be used to provide context to the sender's environment and can be encoded in the context signal used to provide a family member or other person in receipt of such encoded context signal with a potentially enhanced informational experience.

The mobile devices of today integrate additional hardware functions and features over their predecessors including sound, haptics, lighting, location, calendaring, acceleration (using an accelerometer) and time. Such integration enables the conveyance of a richer user context representation in a personal and family security environment as contemplated herein. In current I'm OK applications, the receiving family member will receive a location indication, text message and optional image embedded in the MMS message but other information is not encoded to fully utilize the integrated features found in current mobile phones for example.

One simple example can incorporate sound into the I'M OK multimedia message. As the user initiates an I'm OK MMS message, additional contextual information can be provided in the way of sound clips that can be resident in the device remotely retrieved if necessary. For example, if the user location is at an airport, then a sound clip of an airplane landing or taking off is inserted into the I'm OK Multimedia Message. Technically, deriving location information or inferring location is well known in the art. For example, a mobile device tracking the direction and heading into an airport (particularly at a speed for an automobile) can indicate a sound of the airplane taking off while a location within the airport without previous history of arriving at the airport would indicate a landing sound clip. Other location information can be inferred by entries within the user's calendar.

Other sound insertion examples can include 1). I'm OK at School—sound clip of a school bell is inserted in the message. 2). I'm OK at work—a sound clip of a jack hammer is inserted in the message. 3). I'm OK in the City—a sound clip of traffic. 4). I'm OK at home—a sound clip of tweety bird.

In another example where haptics are incorporated into an I'M OK message, the use of an accelerometer within a mobile device can enable the sender of an I'm OK message to also include their heart rate as part of the family experience. In one example, the accelerometer measures the user's heart rate and determines the pattern of vibrational pulses (frequency and strength) that are encoded into the multimedia message when the user desires to send the I'm OK message. The family member can receive the message and also feel the sender's heart rate as well as strength or intensity of such heart beat. This haptic information contained in the message may not be completely accurate but can relate more of an intangible well being of the family member. It can be used to surmise if the sender is either in an excited or a calm state. In another use case, the use of haptics can be used to indicate movement or riding conditions of the user sending the message. Some possible examples include: 1). Stop and Go traffic while riding public transportation or driving a car can be simulated by pulsing the vibrator in an erratic manner, while riding or driving on the interstate can be simulated by a smooth low force vibration. 2). Standing, walking, running or jogging conditions can be determined through an accelerometer and conveyed in the I'm OK message in a similar manner. In another example, outside weather conditions can be provided through haptic information. Climatic weather such as rain, hail and snow can be implied in the I'm OK message. This can be accomplished by the mobile device “listening” for the frequency spectrum of raindrops and providing a corresponding encoding for the frequency and strength of the rain drops. A similar implementation would be realized for hail and snow.

Using lighting attributes to reflect changing environmental conditions in an I'm OK message can further extend the usefulness of a particular message in a personal and family security environment. Capturing this characteristic in the I'm OK multimedia message can be accomplished by changing the attributes of the message color, text or other content, based on the condition of the sender at the time the message was sent. For example, a message received with a green background can indicate the sender was standing still at the time. A yellow background can indicate the sender was walking at the time the message was sent and the user's condition may change slowly. A red background can be used to indicate the sender was moving at a higher rate of speed such as in a car, bus or train and the user's condition might change rapidly.

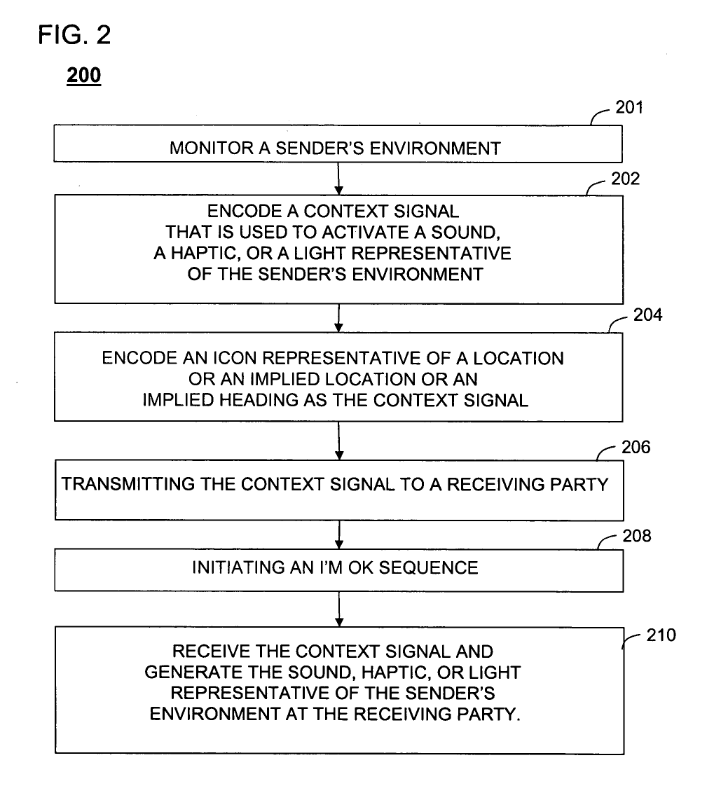

Referring to FIG. 2, a method 200 of conveying context information in a personal and family security environment can include the step 201 of monitoring a sender's environment, encoding at step 202 a context signal that is used to activate a sound, a haptic, or a light representative of the sender's environment, and transmitting the context signal to a receiving party at step 206. In another aspect, the method 200 can alternatively encode an icon representative of a location or an implied location or an implied heading as the context signal at step 204. The method 200 can further include the step of initiating an I'm OK sequence at step 208. In one aspect, the method can receive the context signal and generate the sound, haptic, or light representative of the sender's environment at the receiving party at step 210. A speaker at the receiving party can generate a sound representative of encoded location information at the sender's environment, a vibrator at the receiving party can generate a haptic representation of an encoded heart beat, or traffic condition, or weather condition, or motion condition of the sender's environment, and a light source at the receiving party can generate a background color representative of a motion condition of the sender's environment.

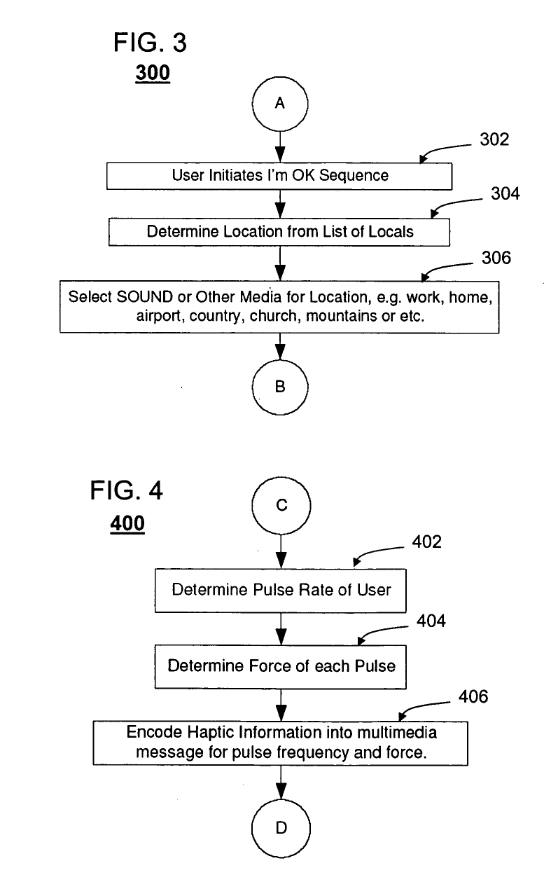

Referring to FIGS. 3 and 4, although the potential examples of the various implementations herein can be quite numerous, a method 300 and a method 400 provide simple examples of how location and sound (or other media) in one instance and how haptic information in another instance can enrich the source of information a recipient receives in a personal and family security environment. In the case of method 300, a user can initiate an I'm Ok sequence at step 302 and further determine at step 304 a location from a list of locations that might best match information confirming such information at a wireless communication device. More particularly, a wireless communication device such as a cellular phone can use GPS capabilities or color codes (Base station Identifiers) to correlate location information. Once such location is determined at step 304, a sound or other media can be selectively associated with the location at step 306 and encoded for receipt by a recipient who can likely associate the context (in terms of location, circumstance, weather, urgency, etc) from where the sender sent his or her I'm OK message. In the case of method 400, a pulse rate of a user can be determined at step 402 and the force of each pulse can be determined at step 404. At step 406, haptic information can be encoded into a multimedia message that can reflect the pulse frequency and force.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of conveying context information in a personal and family security environment, comprising the steps of:
monitoring a sender's environment;
encoding a context signal that is used to activate a sound, a haptic, or a light representative of the sender's environment; and
transmitting the context signal to a receiving party.

2. The method of claim 1, wherein the method further comprises the step of initiating an I'm OK sequence.

3. The method of claim 1, wherein the method further comprises the step of receiving the context signal and generating the sound, haptic or light representative of the sender's environment at the receiving party.

4. The method of claim 1, wherein a speaker at the receiving party generates a sound representative of encoded location information at the sender's environment.

5. The method of claim 1, wherein a vibrator at the receiving party generates a haptic representation of an encoded heart beat, or traffic condition, or weather condition, or motion condition of the sender's environment.

6. The method of claim 1, wherein a light source at the receiving party generates a background color representative of a motion condition of the sender's environment.

7. The method of claim 1, wherein the method alternatively encodes an icon representative of a location or an implied location or an implied heading as the context signal.

8. A personal and family security device, comprising:
a transceiver;
a processor coupled to the transceiver;
a speaker, or color display, or vibrator coupled to the processor;
wherein the processor is programmed to:
activate the speaker, or color display, or vibrator in a manner representative of a sender's environment.

9. The personal and family security device of claim 8, wherein the speaker generates a sound representative of encoded location information at the sender's environment.

10. The personal and family security device of claim 8, wherein the vibrator generates a haptic representation of an encoded heart beat, or traffic condition, or weather condition, or motion condition of the sender's environment.

11. The personal and family security device of claim 8, wherein the light source generates a background color representative of a motion condition of the sender's environment.

12. The personal and family security device of claim 8, wherein the transceiver receives an encoded signal representative of the sender's environment in the form of an icon representative of a location or an implied location or an implied heading.

13. The personal and family security device of claim 8, wherein the speaker, or color display, or vibrator is activated in response to receiving an I'm OK message from a family member.

14. A system of conveying context information in a personal and family security environment, comprising
a first transceiver;
a first processor coupled to the first transceiver;
wherein the processor is programmed to encode a context signal representative of a sender's environment;
a second transceiver;
a second processor coupled to the second transceiver'
a speaker, or color display, or vibrator coupled to the processor;
wherein the second processor is programmed to activate the speaker, or color display, or vibrator in a manner representative of the sender's environment in response to receiving the context signal from the first transceiver.

15. The system of claim 14, wherein the speaker generates a sound representative of encoded location information at the sender's environment.

16. The system of claim 14, wherein the vibrator generates a haptic representation of an encoded heart beat, or traffic condition, or weather condition, or motion condition of the sender's environment.

17. The system of claim 14, wherein the light source a background color representative of a motion condition of the sender's environment.

18. The system of claim 14, wherein the second transceiver receives an encoded signal representative of the sender's environment in the form of an icon representative of a location or an implied location or an implied heading.

19. The system of claim 14, wherein the speaker, or color display, or vibrator is activated in response to receiving an I'm OK message from a family member.
